(19) United States
(12) Patent Application Publication
(10) Pub. No.: US 2023/0133813 A1
(43) Pub. Date: May 4, 2023

(54) SOFTWARE CLASS OBJECT STRUCTURE, SYSTEM, AND METHOD FOR E-COMMERCE GIFT CARD PRODUCTION, DISTRIBUTION AND FULFULLMENT IN COMPLIANCE WITH THE THREE-TIER REGULATORY STRUCTURE FOR BEVERAGE ALCOHOL

(71) Applicant: THIRSTIE, INC., New York, NY (US)

(72) Inventors: Devaraj Southworth, New York, NY (US); Maxim Razmakhin, New York, NY (US)

(21) Appl. No.: 17/689,968

(22) Filed: Mar. 8, 2022

Related U.S. Application Data
(60) Provisional application No. 63/158,207, filed on Mar. 8, 2021.
(60) Provisional application No. 63/224,780, filed on Jul. 22, 2021.

(51) Int. Cl. G06Q 20/34; G06F 8/20

(52) U.S. Cl. CPC G06Q 20/3433; G06Q 20/342; G06F 8/24

(57) ABSTRACT

Embodiments described herein relate to a software class object structure, system, and method for e-commerce gift card production, distribution and fulfillment in compliance with the three-tier regulatory structure for beverage alcohol.

### CROSS-REFERENCE TO RELATED APPLICATIONS

This application claims priority to U.S. Provisional Patent Applications 63/158,207, filed on Mar. 8, 2021; and 63/224,780, filed on Jul. 22, 2021; both of which are incorporated by reference herein in their entirety.

### FIELD OF THE DISCLOSURE

Embodiments of the presented invention relate to systems and method to manage the design, production, distribution, and redemption of third-party gift cards which include brand advertising, for use within a third-party e-commerce system for beverage alcohol (or other regulated products) to provide branded gifting opportunities to customers.

### BACKGROUND

Gift cards are a popular and widely used mechanism that provide advantages for consumers who are looking for ease and convenience in giving gifts, retailers who are looking to increase sales, and brands who are looking to promote their products and attract new consumers to try their products.

In the general sense, a gift card is a physical card or electronic code that a customer uses as a payment method. This payment method adds a balance to a single customer's account, which can be redeemed at a select store or set of stores. The balance can be applied in full or partially to any number of purchases, so long as the total of a single purchase does not exceed the remaining balance on the gift card. Because a gift card is essentially a payment method, it can be redeemed independent of other discounts / promos. In other words, application of a promo code to discount an order total does not preclude a customer from also using their gift card to pay for the order.

The balance on a gift card can expire if left unused, but many states have their own sets of regulations on how to handle the unused balance. For example, gift cards issued in California have a balance that does not expire, and if the value of a card is under $10, the customer can cash out the remaining balance.

For the retailer, the sale of a gift card is recorded as a credit to liability (gift card or unearned revenue), with a debit to cash. When the gift card is redeemed, the liability is shifted to a sales transaction.

Gift card offerings are very popular for e-commerce retailers. While the purchase of the gift card itself is essentially a form of unearned revenue for the retailer, the likelihood of someone redeeming that card is extremely high. Gift cards nearly guarantee at least a single purchase is made by a customer from the issuing store. They also can help drive higher value purchases, as if a customer has a willingness to pay for a product, the WTP can be added to the gift card value to increase the value of a basket. Still further, if a first-time purchaser has a good experience using their gift card, two customers can be acquired—the gift giver (“gifter”) and the gift recipient. Building brand loyalty with either or both of these customers can increase long-term customer value substantially.

Another reason for the popularity of gift cards is the variety of ways in which they can be configured. Gift cards can be issued in physical or digital form, and either as open-loop (redeemable at any retailer for any product, like a traditional credit card) or closed-loop (redeemable for a specific product or at specific retailers only).

Gift cards have increased in use and popularity with the rise of e-commerce as both physical and digital cards can be used to encourage consumers to visit a retailer or brand's website or mobile app. Also, gift cards can usually be easily redeemed through standard e-commerce payment processing methods. However, this is not the case for gift cards for beverage alcohol which will be redeemed over e-commerce.

The beverage alcohol industry is a massive segment of the United States retail economy, totaling over $250 billion in sales annually. For comparison, that is more than 20× larger than the coffee industry. The alcohol industry is also heavily regulated. Since the repeal of prohibition by the 21st amendment in 1933, liquor brands have been restricted from engaging with or selling directly to consumers in all but very limited situations. They are also restricted from selling products directly to retailers, or even to provide value to a retailer in exchange for selling the brand's products. Further, retailers must obtain licenses to sell beverage alcohol, and the requirements and regulations governing the sale of alcohol can vary from state to state. The term for this regulatory structure is the “three-tier” system, referring to the three-tiers of product producers/suppliers (brands), wholesale distributors, and retailers.

Beverage alcohol is also one of the most gifted products in the United States, with over 20% alcohol products in the U.S. being purchased to be given as a gift. However, due to challenges presented by the regulatory environment described above, the usage of gift cards by brands to promote their products and to make it easier for consumers to gift the brand's products, has not been possible. A brand cannot sell gift cards directly to consumers, because that would be equivalent to the sale of an alcohol product. Also, since a brand cannot favor one retailer over another, the distribution and redemption of a branded gift card is problematic, because in theory the consumer may try to redeem the gift card at any one of thousands of licensed retailers.

Thus, a need exists for systems and methods to manage the issuance, distribution and redemption of a gift card which carries a brand's promotional materials in conjunction with a regulatorily compliant third-party provider (TPP) e-commerce system, and a branded third-party gift card for regulated products.

There is also a need for TPP e-commerce systems that provide the infrastructure for licensed entities in the three-tier system perform the same functions in an online context as they do in traditional brick and mortar commerce. (See, https://brooklynworks.brooklaw.edu/blr/vol83/iss1/17). Such systems must ensure that all aspects of commercial transaction, including payments, order fulfillment and product delivery, occur under the full control of a licensed retailer, and that the boundaries of the three-tier system are maintained. For example, technological solutions are needed to ensure that the laws and regulations of the three-tier system are followed, such as with respect to holding and movement of payment funds by and to the proper entities, without improper entities ever holding payment funds, and further without creating an inconvenient and difficult to use system for online consumers. Moreover, technological solutions are needed to ensure that when a gift card for beverage alcohol is sold, and then redeemed, the regulated product gift card management system and method presents the expected data, formatting, and prompts expected by typical/conventional e-commerce systems, such that the inputs and actions of the regulated product gift card management system are not rejected or refused by conventional e-commerce systems, credit card processors, and other software and entities typically involved in an e-commerce transaction.

Further, while the TPP e-commerce system is not under the regulatory jurisdiction of state alcohol control boards, various control boards have issued advisory guidelines on the activities of TPPs (https://www.abc.ca.gov/third-party-providers/; https://abra.dc.gov/sites/default/files/dc/sites/abra/publication/attachments/Online_Providers_Ad_Opinion.pdf; https://www.tabc.texas.gov/static/sites/default/files/2020-06/mpa-056.pdf). Thus, there is a need for any TPP e-commerce system to be compliant with such state alcohol control boards, as well as, if needed, local municipality alcohol laws and regulations.

There is also a need for Branded Gift cards issued by a TPP e-commerce system to provide consumers additional gifting options, as a gift card purchased even if the retailer does not have the product in stock. There is also a need for Branded Gift cards which may be easier to give as gifts, if the logistics of giving a bottle of wine or spirits is difficult for the gifter. Finally, there is a need for a branded third-party gift card that is more convenient as a last-minute or impulse purchase by a gifter, rather than the purchase of the physical product, and which may be used in a manner that handles payments in a manner compliant with the TTP.

Finally, there is a need for enabling branded gift cards through a compliant TPP e-commerce system that allows both the brands and retailers involved to garner additional information regarding their consumers and thereby provide targeted marketing and benefit from general consumer insights.

### SUMMARY

Embodiments of the invention relate to a system, methods, and apparatus to manage the design, production, distribution, and redemption of branded third-party gift cards for use within a third-party e-commerce system for beverage alcohol (or other regulated products) to provide branded gifting opportunities to customers. This allows the producers of regulated products to enable consumers branded gifting experiences and enables the use of both physical and digital gift cards with online e-commerce activity. As explained herein, certain embodiment of the system and method are accomplished using a novel software class object structure.

In a first aspect of the technology disclosed herein, software class object structure for enabling the issuance and redemption of a third-party gift card for the gifting of beverage alcohol, which includes brand marketing information, and which is configured to provide data for transactions in a manner that such data integrates into a conventional third-party e-commerce platform is disclosed that is made up of a gift card object including a gift card code field, a gift card value field, a gift card format definition, a product set comprising a pointer to a set of authorized products, a storefront set comprising a pointer to a set of authorized storefronts, a first gift card object executable code for creating a gift card, comprising code to execute the steps of issuing of a unique gift card code and populating the unique gift card code in the gift card code field, issuing a security code to be used to securely activate the gift card, and creating either a data set to separately manufacture a physical gift card, or creating a virtual representation of the gift card to allow the recipient of the gift card to access the unique gift code, a second gift card object executable code for getting gift card details including a list of storefronts, retailers, and products eligible for gift card redemption, a list of any geographic restrictions on gift card redemption, a current balance of the gift card, and a status of the gift card, a third gift card object executable code to authorize an activation code for the gift card, and, a fourth gift card object executable code to activate the gift card using a user detail data and a location data, where the gift card object instantiates a gift card recipient object, where the gift card recipient object includes a first recipient id field, a first gift card id field, a first user id field, a first gift card recipient object executable code to check the status of the recipient and a second gift card recipient object executable code to set a location id field, where the gift card recipient object instantiates a gift card locale status object, where the gift card locale status object includes a second recipient id field, which is populated by the data from the first recipient id field, a second gift card id field, which is populated by the data from the first gift card id field, a first gift card locale status object executable code to set the gift card locale status, a second gift card locale status object executable code to get the gift card local status and a third gift card locale status object executable code to get a locale products list, a logistic order object comprising, a second user id field which is populated by the data from the first user id field, a second gift card id field which is populated by the data from the first gift card id field, an other payment details field, an order details field, a first logistic order object executable code to validate the gift card payment status, and a second logistic order object executable code to instantiate a gift card redemption object, wherein the logistic order object instantiates a gift card redemption object, wherein the gift card redemption object includes a third recipient id field, which is populated by the data from the second recipient id field, a third gift card id field, which is populated by the data from the second gift card id field, a redemption amount field, a logistic order id field, a status field, a timestamp field, a first gift card redemption object executable code to validate the redemption status, a second gift card redemption object executable code to complete redemption of the gift card, including the step of effecting the transfer of funds from a gift card account to a retailer account thereby fulfilling redemption and where the gift card redemption object is configured to call the recipient status executable code and the get local products executable code.

An embodiment of the first aspect is disclosed where the security code is stored separately and functions as a password to access funds associated with the gift card.

An embodiment of the first aspect is disclosed where the representation of the gift card is stored in the gift card recipient object.

An embodiment of the first aspect is disclosed where a list of storefronts, retailers, and products is stored in a retailer storefront mapping object.

An embodiment of the first aspect is disclosed where a list of geographic restrictions are stored in a gift card locale status field in the gift card locale object.

An embodiment of the first aspect is disclosed where a current balance of the gift card is stored in the gift card object.

An embodiment of the first aspect is disclosed where the first gift card recipient object executable code to check the status of the recipient is configured to perform an age verification routine to verify that the individual redeeming the gift card is old enough to purchase beverage alcohol.

An embodiment of the first aspect is disclosed where the logistic order object also includes a first other payments detail executable code, which uses any data present in the other payment details field to determine if an additional payment over and above the current balance on the gift card is required to complete a requested purchase.

An embodiment of the first aspect is disclosed where the second logistic order object executable code includes code to perform preauthorization of an amount needed to be redeemed, thereby placing a hold on funds so as to prevent two simultaneous transactions to redeem the funds twice from the same gift card.

An embodiment of the first aspect is disclosed that also includes a retailer object including an id field, a name field, a details field, a retailer storefront selection executable code for subscribing to a retailer storefront mapping object, and a get retailer inventory object for accessing an inventory object, the inventory object including a first retailer id field, a product reference field, a price field, and a quantity field, a retailer storefront mapping object including a second retailer id field, populated with data from the first retailer id field, a storefront id field, populated with data from the id field, an active field, comprising a first Boolean operator to indicate whether the storefront object includes active products for offer, a giftcard payments field, comprising a second Boolean operator to indicate whether the storefront object is accepting payments by gift card, a get store fronts for retailer executable code which uses the second retailer id field, a get retailer inventories for storefront executable code which retrieves a list of products to be advertised via a storefront object, a storefront object including a second id field populated by the data from the first id field, a type field identifying the type of ecommerce application in use, a second name field populated by the data from the first name field, a brand field, where the retailer object is configured to facilitate online advertising of inventory that is for sale based upon the inventory object data fields, where the retailer object subscribes to the retailer storefront mapping object and where the retailer storefront mapping object retrieves the list of products to be advertised based upon the storefront object data fields.

In a second aspect of the technology disclosed herein, a method is disclosed to enable an online customer to purchase a gift card for the purchase of beverage alcohol via a third-party e-commerce platform (TPP), simultaneously with the online purchase of beverage alcohol for the online customer, through a single checkout experience, while maintaining compliance with three-tier regulatory system for beverage alcohol by carrying out the following steps (a) accepting customer input through the TPP interface of the geographic location and form of delivery for the gift card or cards to be purchased; (b) accepting customer input through the TPP interface of the value to be loaded onto the gift card at activation; (c) recording the purchase of the gift card with the above details in the TPP system; (d) determining if the customer payment methods can be used to purchase a gift card and performing regulatory checks to verify that the customer is eligible to purchase a gift card to be used in the later purchase of alcohol; and (e) transferring the funds represented by the gift card to a segregated account and recording the status of the gift card as ready for activation.

In an embodiment of the second aspect, the method further includes accepting customer input to select whether the gift card will be issued in physical or electronic form.

In an embodiment of the second aspect, step (d) includes performing age verification.

In a third aspect of the technology disclosed herein, a method is disclosed for a retailer to dynamically update a list of retailers with whom a gift card can be redeemed in payment for the fulfillment of beverage alcohol in compliance with the three-tier system, where the retailer is not the issuer of the gift card, including the steps of: (a) enabling the retailer to select branded e-commerce storefronts on which to advertise beverage alcohol products for sale; (b) collecting payment account information from the retailer; and (c) collecting the retailer's opt-in confirmation to receive payments via gift card redemption.

In a fourth aspect of the technology disclosed herein, a method is disclosed to enable a customer to redeem a gift card to purchase beverage alcohol and other non-alcohol products through an e-commerce storefront supported by a third-party platform (TPP) by processing payments directly to an online retailer from the gift card in compliance with the three tier system, including the steps of: (a) checking a list of products and retailers eligible for gift card redemption to identify which products chosen for purchase by the customer can be purchased using gift card funds; (b) preauthorizing gift card redemption when the customer initiates checkout during their e-commerce shopping session; (c) creating a transaction for the amount of the purchased goods from the gift card account to the retailer; (d) collecting any other payments from the customer if there are amounts due to the retailers that cannot be paid from the gift card; (e) voiding the customer order in full if the gift card and other payment transaction is not able to be processed; and (f) completing all payment transactions to effect the movement of funds only if steps a-d are successfully completed.

### BRIEF DESCRIPTION OF THE DRAWINGS

FIG. 1 is a flow diagram of the steps in the issuance, redemption and fulfilment of an order placed using one embodiment of the branded third-party gift card for regulated products, in physical form;

FIG. 1a is a flow diagram showing one variant with the card issued in digital form;

FIG. 2 shows exemplar design options for a beverage alcohol gift card that allow the brand producer to showcase their products and the placement of legal disclaimers—which include the prominent message that licensed retailers, and not the brand, are responsible for all final transactions involving the sale of alcohol for all orders that the consumer places on the TPP e-commerce system;

FIG. 3 shows an exemplar of the redemption process on a branded storefront website, which provides a similar user experience for consumers who are accustomed to purchasing from a website with credit cards;

FIG. 4 shows the logistics flows for the e-commerce fulfillment of an order of beverage alcohol purchased in whole or part with a gift card, in such a way that the promoted brand plays no role in the fulfillment process and thus remains in compliance with the three-tier system;

FIG. 4a shows an alternative logistics flow chart for e-commerce fulfillment of an order of beverage alcohol in compliance with the three-tier system;

FIG. 5a shows the first of three different money flow pathways for a third-party gift card with brand identifying assets, namely an open loop flow;

FIG. 5b shows the second of three different money flow pathways for a third-party gift card with brand identifying assets, namely a closed loop flow;

FIG. 5c shows the third of three different money flow pathways for a third-party gift card with brand identifying assets, namely through a separate retail network;

FIG. 6 shows a flow diagram depicting the processes of an embodiment that enables the issuance, activation and redemption of a branded gift card used to purchased regulated products;

FIG. 7 shows a data flow diagram with the entities, processes and data stores used in the system implementation of an embodiment;

FIG. 8 shows a software class object structure with the class objects utilized by a computer program that implements the process in FIG. 7;

FIG. 8a shows a software class object structure with class objects utilized by a computer program to enable retailer opt-in to the system and process in FIG. 7;

FIG. 9 provides an entity relation diagram for the data stores depicted in FIG. 7;

FIG. 10 shows a flow diagram wherein the TPP system creates a record of the Gift Card and creates a database record linking the card to a specific set of storefronts and products. Note that these sets may consist of empty lists at the time of gift card issuance, see the data schema provided in FIG. 9;

FIG. 11 is a partial listing of pseudocode for the software class objects, schemas, processes and functions addressed herein; and

FIGS. 11a-g are a continuation of the FIG. 11 listing of pseudocode for the software class objects, schemas, processes and functions addressed herein;

### DETAILED DESCRIPTION OF THE EMBODIMENTS

To aid the reader, and to clarify the disclosure herein, Applicant provides the following glossary of terms used herein.

Three-tier System: The set of regulatory constraints that have governed the sale and distribution of beverage alcohol in the United States since the end of prohibition. The three-tier system divides activity into three separate groups and entities need a license to operate in any group or tier. Entities are generally prohibited from operating in more than one tier. The tiers are 1) “Suppliers” who can produce or import beverage alcohol products, “Distributers” who act as wholesalers and 3) “Retailers” who can sell beverage alcohol products to consumers. Suppliers are restricted to selling products only to Distributers who are the source of products for licensed Retailers.

Gift Card: Also, “Stored Value” card, can be physical or virtual. Represented by a BIN number or gift card code, typically 16-19 digits, which is a unique representation of the gift card. The gift card is a money product, representing a specific face value for which the card can be redeemed for purchases from specific retailers.

Gift Card Program: Also, “BIN range” is a set of Gift Cards that have been approved for issuance by the Gift Card issuer—represented by a range of potential gift card code. The Gift Card Program includes marketing materials and branding that determine how the gift card is packaged.

Gift Card Account: A payment account holding the funds that each specific gift card represents.

Gift Card Issuance: The selection of a specific Gift Card, and associated gift card code that can be sold to a consumer. The Gift Card is issued with the ability to have a specific amount of funds loaded onto the card during Activation, or a range of values, but does not yet constitute a claim on any funds.

Gift Cart Activation: After issuance funds are loaded onto a gift card, and funds are transferred to the Gift Card Account. Once activated the Gift Card acts as a claim on those funds.

Claim a gift card: The process by which the gift card recipient, i.e the party who intends to redeem the Gift Card for a purchase, accesses the gift card code and any security code needed.

Gift Card Redemption: The process of a customer using a gift card in full or partial payment for a purchase.

Gift Card Pre-Authorization: The process of checking that a Gift Card can be redeemed for a specific amount, and, optionally, for specific products and with other constraints such as delivery restrictions. If authorized, the specified amount is place on hold, so that the same funds cannot be accessed by two separate redemptions.

Gift Card Redemption Completion: The final step in a Gift Card Redemption, funds are permanently removed from the Gift Card and a transaction is created to pay the funds to the redeeming Retailer.

Licensed Retailer: A retailer licensed under the Three-Tier System to sell beverage alcohol to customers within a specific jurisdiction.

TPP: A Third-Party Platform for e-commerce, which provides the technological tools needed to allow customers to purchase products online.

Advertising: The solicitation by a retailer to sell specific products to a consumer or consumers.

Marketing: The act of making a product known to potential customers, includes providing information that the consumer may need to know to make the decision to purchase the product versus other options.

Brand: The Supplier in the Three-Tier System who provides the product with an identity and is responsible for Marketing activities.

Age Verification: Most jurisdictions require consumers to over a certain age to purchase beverage alcohol and other regulated products. Age verification is the process of obtaining from the consumer attestation or proof of age to meet this requirement before being allowed to view advertisements or purchase regulated products.

Branded Storefront: A website, mobile application or other e-commerce sales channel through which a TPP allows Retailers to advertise products from a specific Brand or Brands.

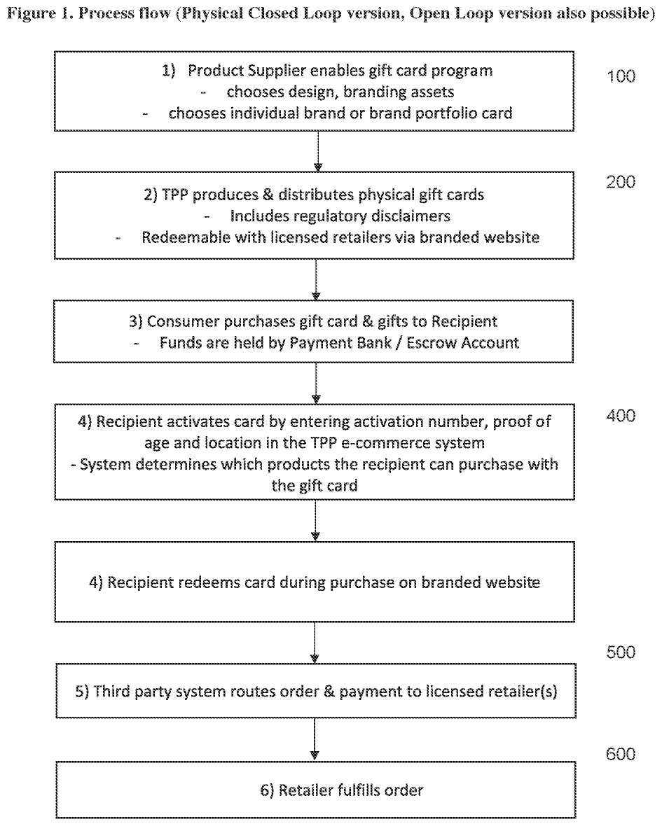

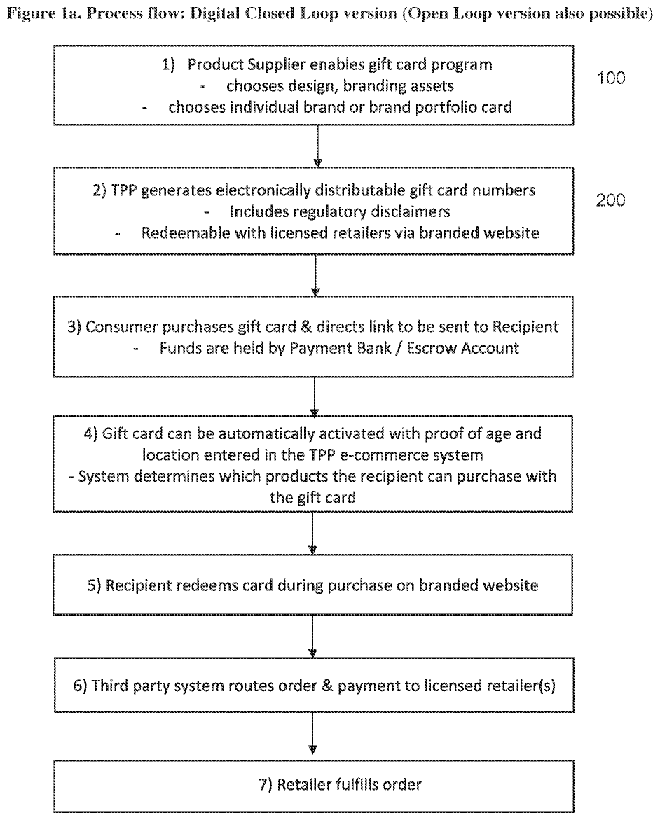

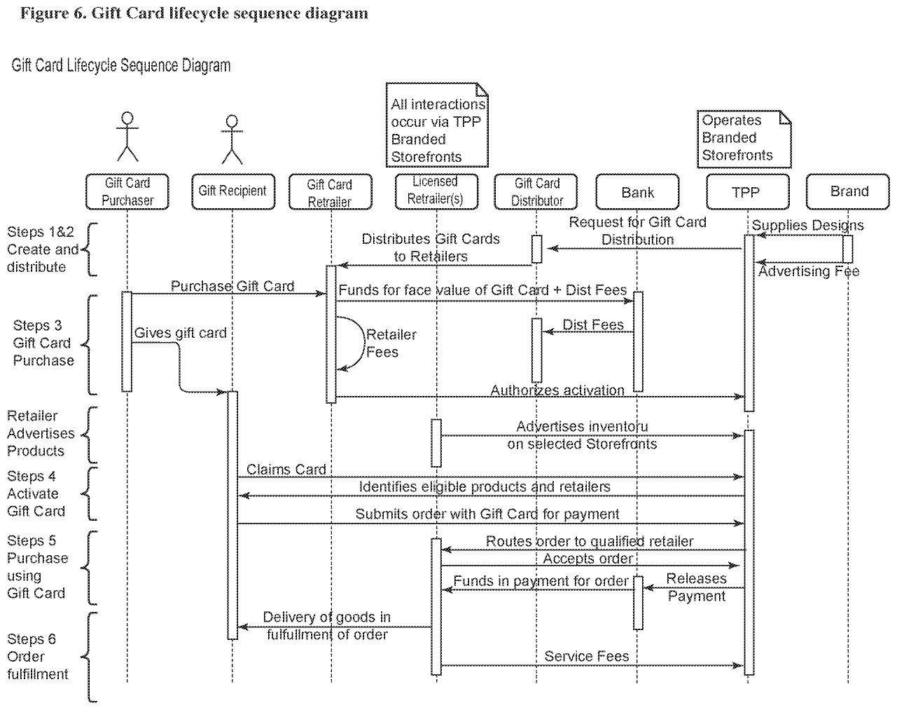

One embodiment of a TPP controlled, branded gift card issued as a physical gift card is illustrated in FIG. 1 and its process flows are also illustrated in FIG. 6.

With reference to FIGS. 1, la, and 6, in step 1, 100, the brand producer selects a design for the physical gift card to promote the brand's product or products, with appropriate disclaimers and details on how to redeem the gift card. In step 2, 200, the TPP e-commerce system captures the requirements, and handles the creation, issuance and distribution of the gift cards to retailers who will be the merchant of record on gift card sales.

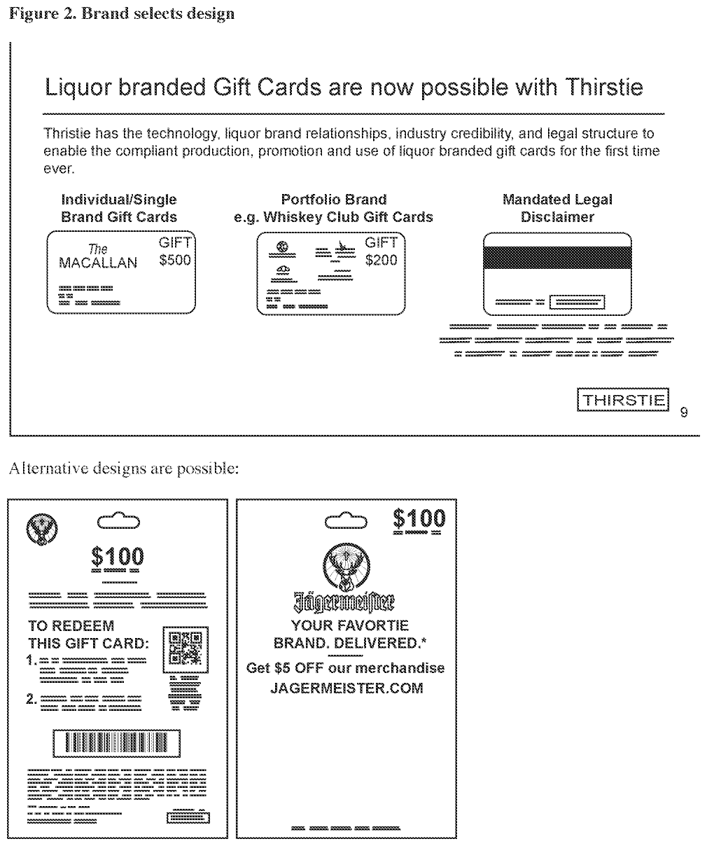

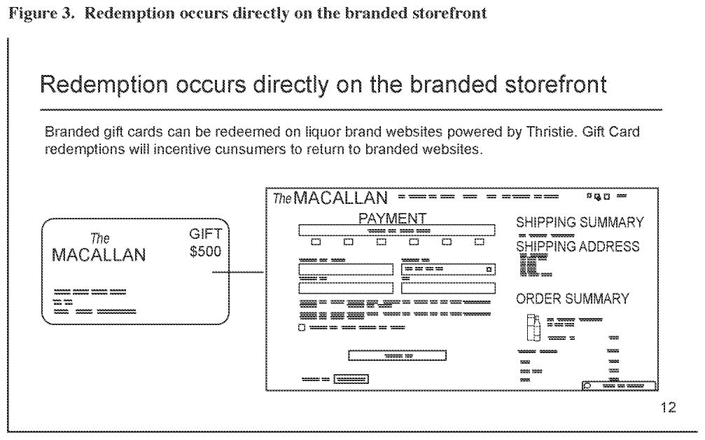

FIG. 2 shows examples of physical gift cards with branded content promoting specific products or product portfolios. The cards also display legal disclaimers—which include the prominent message that licensed retailers on the TPP e-commerce system, and not the brand, are responsible for all final transactions involving the sale of alcohol. These disclaimers are required to maintain compliance with the three-tier system. The illustrated gift cards contain magnetic strips and activation numbers. Variants include utilizing a QR code or scratch-off codes to reveal activation numbers, as well as digital gift cards in which the code is delivered to the user electronically, for example via email or SMS message.

In step 3 of FIGS. 1 and 6, a customer purchases the gift card, and gives it as a gift. The card is activated for the amount of the of the purchase when the retailer records the sale. And funds are held by a Payment Bank. Note that the brand is not in any way a party to this transaction and does not receive payment. The gift card retailer may charge the customer a fee for the sale of the gift card over the face value of the gift card. The gift card represents a claim on the funds deposited to the Payment Bank account, net of any fees charged. These funds are accessible solely through the redemption of the gift card (subject to laws and regulations on escheatment and abandoned property in the case of unused gift cards).

Upon sale of the card, the retailer authorizes the activation of the card, which is recorded by the TPP. This allows the card to be later activated by the recipient. These steps are usually combined in a standard gift card issuance. As a requirement for activation the gift card for beverage alcohol or other regulated products the recipient must confirm that they are eligible to purchase the regulated product (for example, over the age of 21 currently for beverage alcohol purchased in the United States).

Prior to redeeming the gift card, the recipient must activate the card. During activation, the recipient must provide proof of age and the location to which they wish a regulated product to be delivered. The system then verifies that the recipient is in fact legally able to receive delivery of the product from one or more retailers on the TPP e-commerce platform and authorizes the redemption of all or part of the value of the gift card. This creates a method for ensuring the gift card can only be redeemed to purchase the regulated products in locations only where it is allowed (for example, by rejecting a redemption where the purchase of beverage alcohol is prohibited by county or city ordinance), and only by customers who are of legal age. Variants include allowing the gift card recipient to select desired products prior to activation and authorizing redemption, and displaying to the consumer which, if any, of the desired products can be purchased with the gift card.

In one variant, shown in FIG. 1a, certain steps can be handled automatically by the TPP e-commerce system. Instead of purchasing a physical card, the gift card purchaser receives an electronically deliverable token. The TPP e-commerce system can deliver a link that can be used to automatically activate the gift card on verification of age and location.

In step 4, 400 the gift recipient redeems the gift card by placing an order for the promoted beverage alcohol product on the branded website or on a mobile app powered by the TPP. The recipient can provide additional payment if the desired purchase is greater than the value of the gift card. If the purchase is for less that the value of the card, the recipient is notified of the remaining balance and can re-use the gift card (for up to the remaining balance) at a later date.

In step 5, 500 the TPP routes the order for fulfillment by a licensed retailer, who receives payment directly from the gift card Payment Bank. The retailer is not selected until the gift recipient places an order, and the retailer selection is based on the gift recipient's delivery address and any other information needed to ensure the retailer can successfully fulfill the order. The TPP selects a retailer or retailers based on which retailers can legally fulfill the order, at the time of the redemption request. Note, in some cases the gift recipient will be presented with a choice of retailers, based on product or state requirements.

In other variants, the funds could be held: 1) in an escrow account controlled by the TPP, without loss of generality in the method of securing funds to be accessed on the redemption of the gift card; or 2) in a bank account controlled by the original retail seller of the gift card, to be released on redemption of the gift card.

In step 6, 600 the selected retailer fulfills the order and arranges shipment after receiving payment, as they would for any e-commerce order.

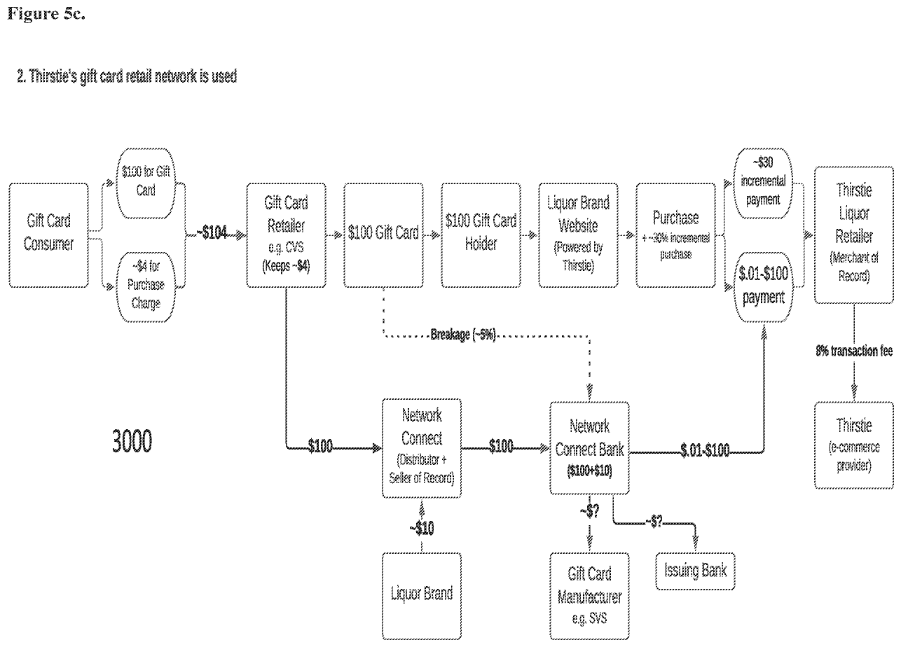

Money flows for three general variants are illustrated in FIG. 5. In the first variant, 1000 the card is issued in open loop format, allowing the card to be redeemed online via the branded website. The funds are stored with a regional bank, but the TPP e-commerce system only allows the card to be redeemed for the specified products.

In the second variant 2000 the card may also be redeemed with any retailer (which would include online via the branded website). Here the brand is providing their customers more flexible gifting options but still promoting their products. The gift card could also be issued in digital format with very similar transaction flows.

In the third variant, 3000 the card is issued as a closed loop card, and instead of utilizing a regional bank to process payments, the funds are held by the TPP and used to provide payment directly to the retailer during checkout.

Other variants could also link branded third-party gift cards to loyalty programs where either the gift card purchaser or gift recipient receive loyalty points towards regulated products, non-alcohol goods or other discounts as allowed by law. The gift cards could also be linked to other promotional activities such as contests, where the contestants would be rewarded with gift cards for the purchase of regulated products, as allowed by law.

With reference to FIGS. 5a-c, three different money flow pathways for a third-party gift card with brand identifying assets are illustrated. The liquor brand is responsible for a fee to cover the expense of the promotional activities. The funds are not for the purchase of any goods, including beverage alcohol, but cover the costs of production and distribution of gift cards. Funds used to purchase goods are fully segregated and provided only by the gift card purchaser, plus any additional amount provided by the gift card recipient if they desire to make a purchase for more than the amount of gift card;

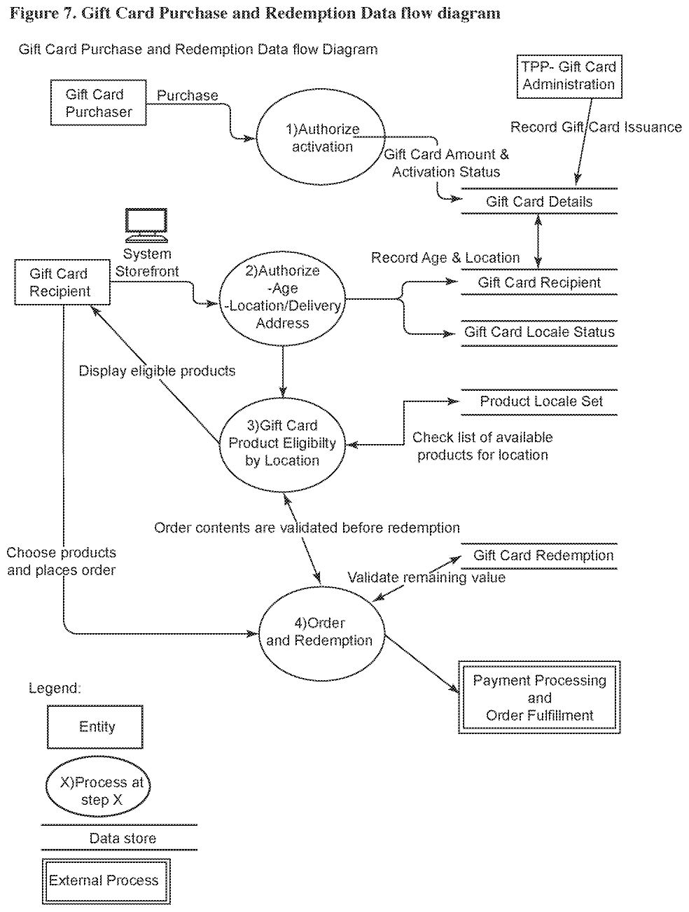

FIGS. 7, 8 and 9 outline the system implementation of an embodiment, which is agnostic to the open loop/closed loop distinction above.

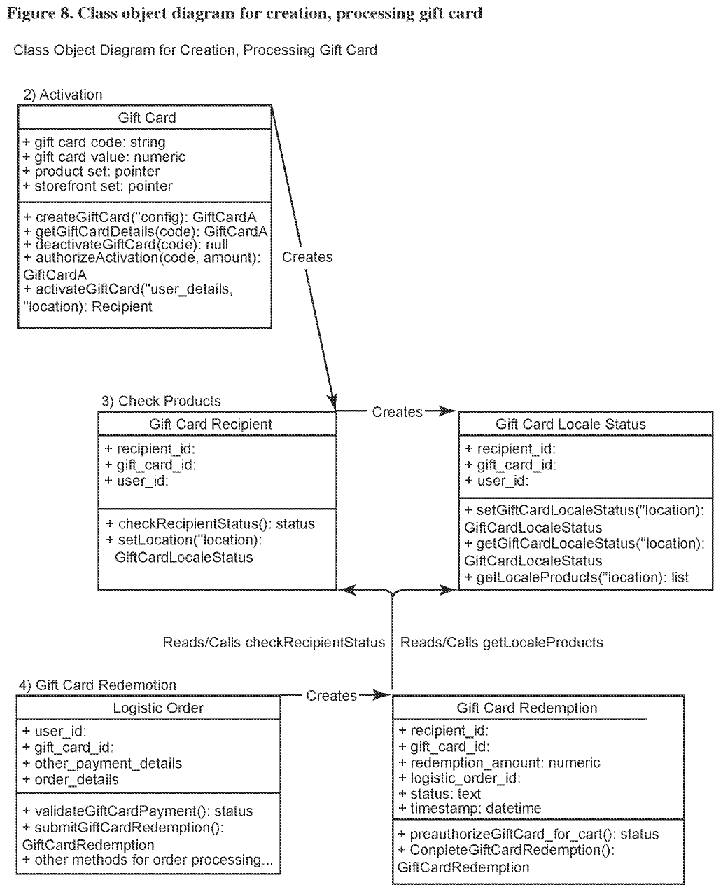

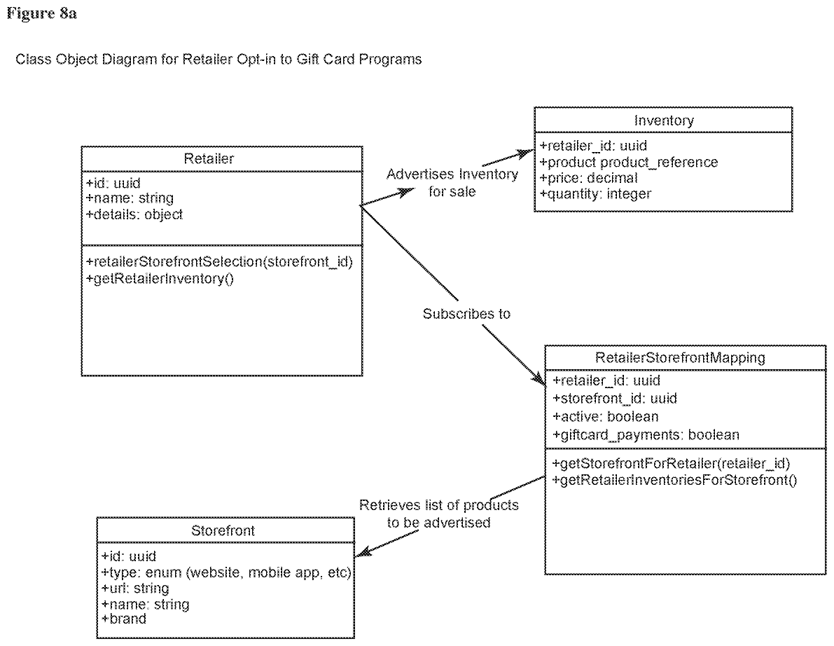

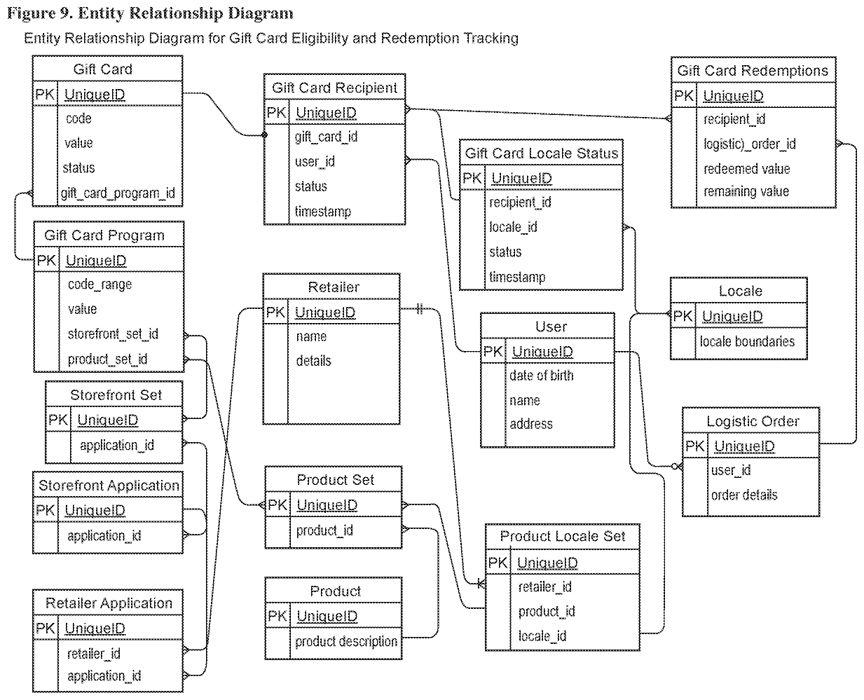

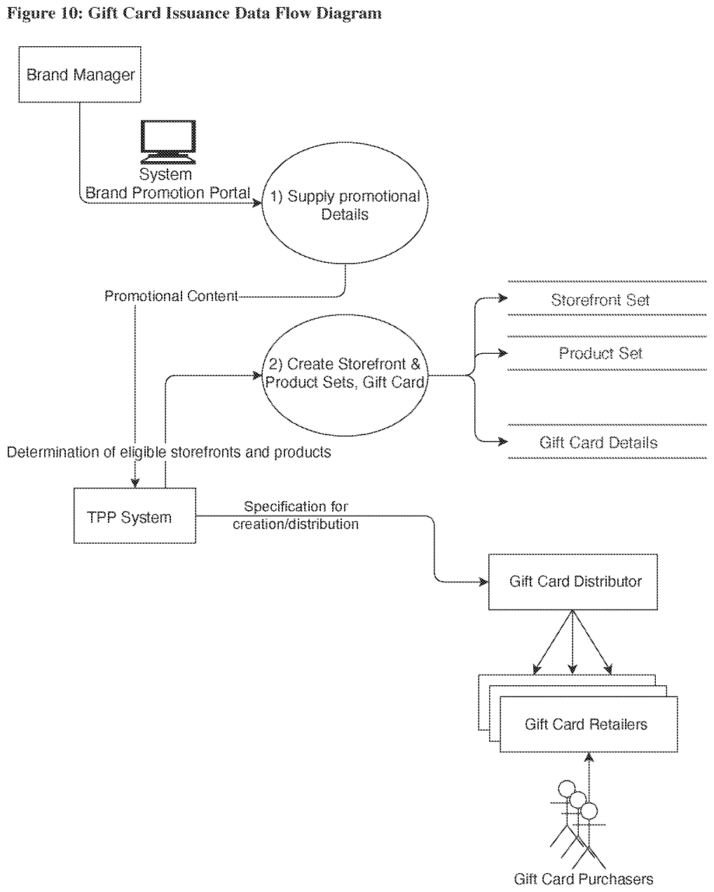

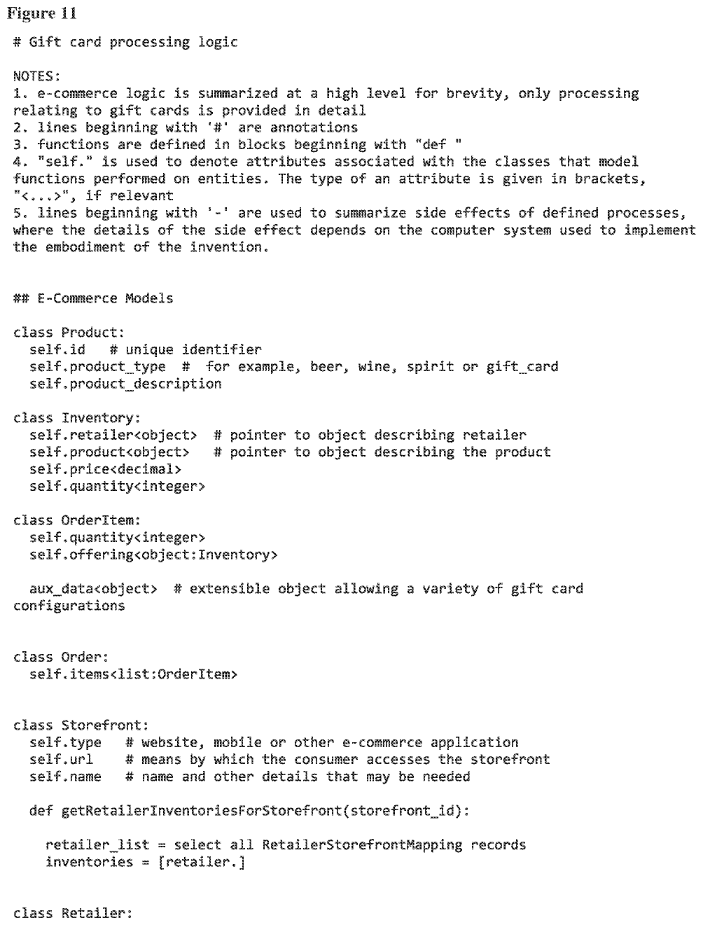

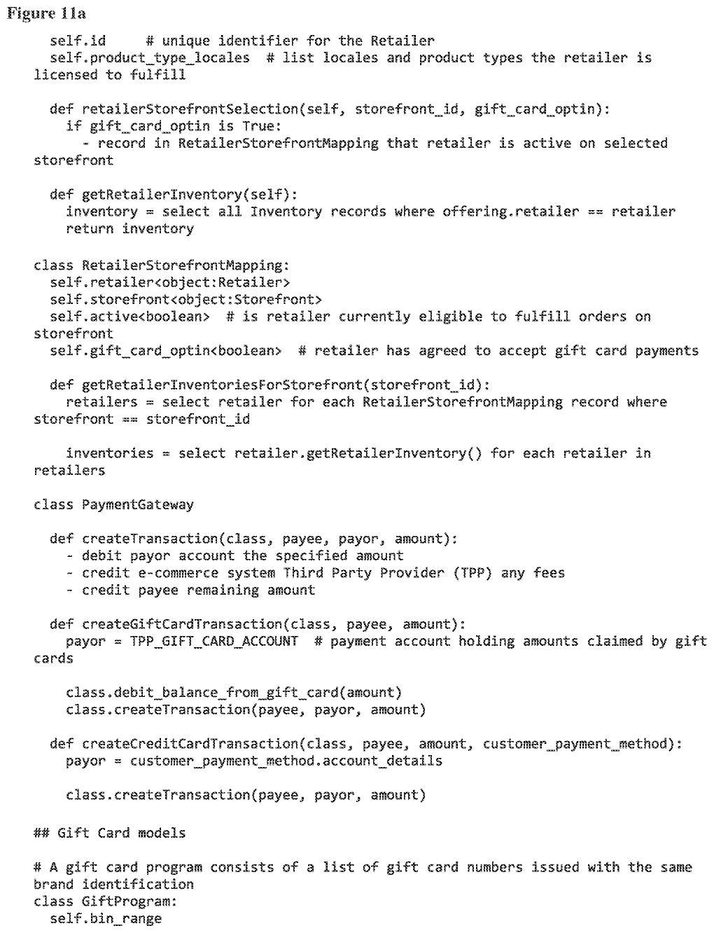

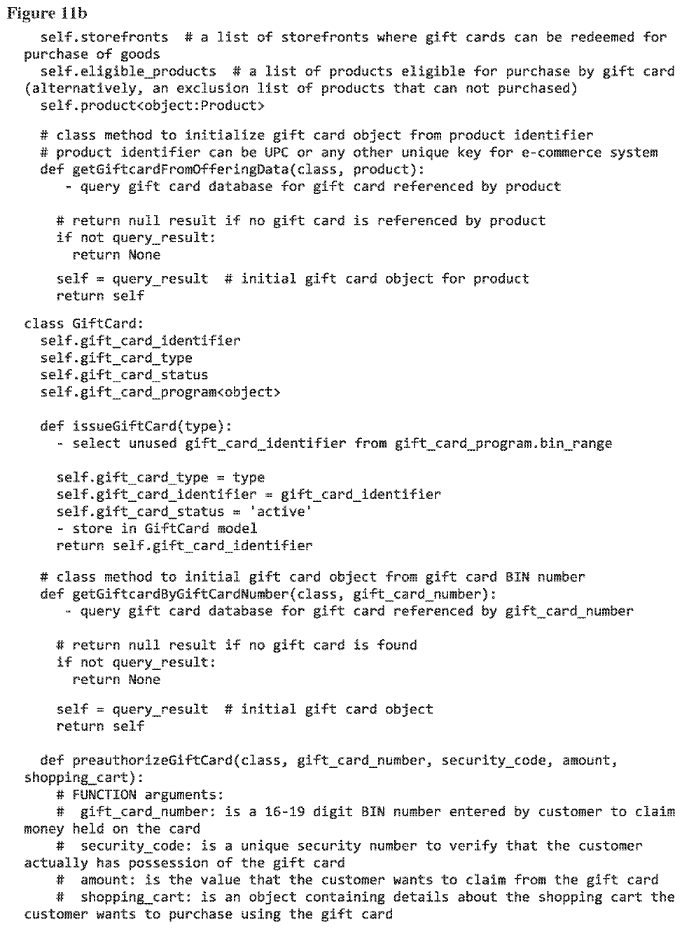

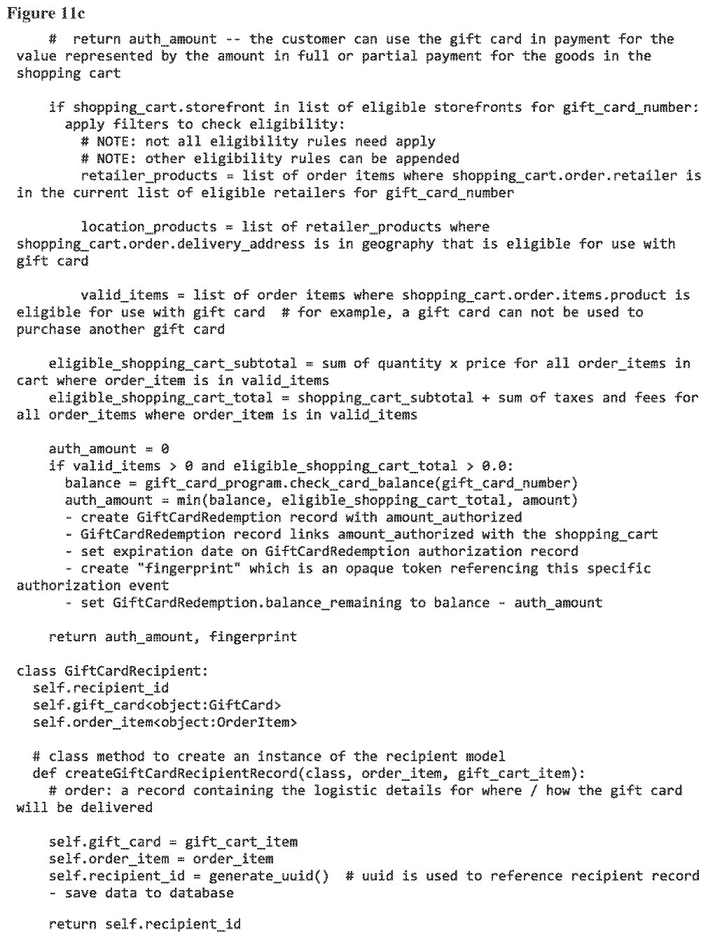

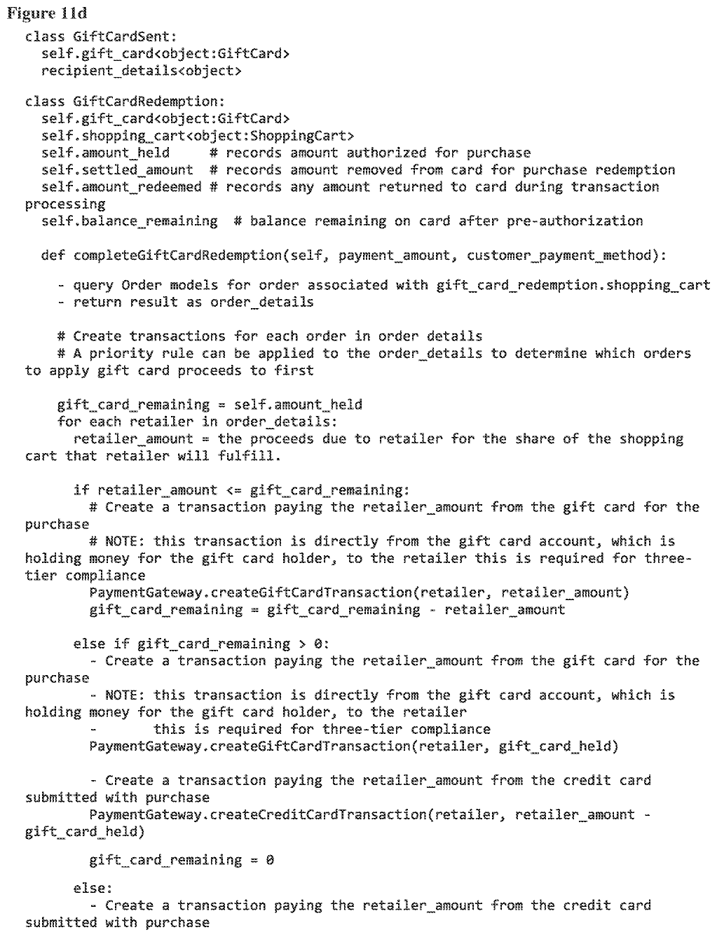

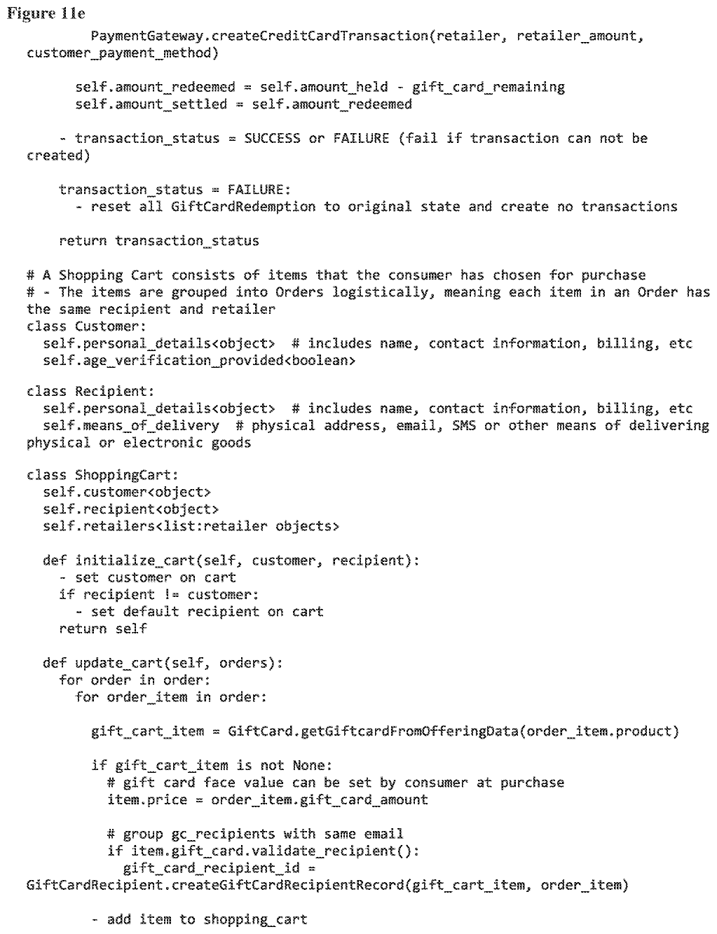

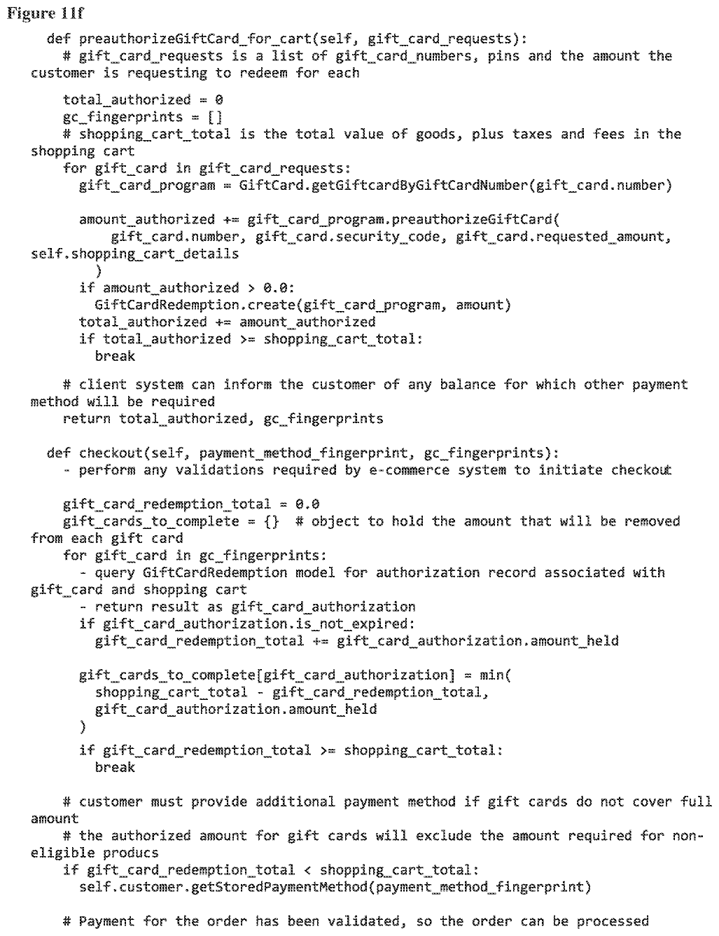

FIG. 7 identifies the two entities who act as agents in the system, the Gift Card Purchaser and Gift Card Recipient. The TPP acts as the administrator of the system and is responsible for recording the issuance of a gift card, and defining its characteristic features which would include: 1) the designation of a “Store Front” or set of Store Fronts, and 2) designation of the Products which are eligible for redemption with any given Gift Card. These are generally the processes carried out and described in FIGS. 1, 1a, and 6. These details are stored in the “Gift Card Details” data store—the details of this data store are shown in FIG. 9. Similarly, the object class definitions and structure for carrying out these processes are shown and described in FIG. 8.

FIG. 7 defines four processes that can be performed in order to complete a gift card purchase, and redemption, for beverage alcohol using the presently disclosed system and method. The first of these processes is “1) Authorize Activation.” In this process the gift card is validated against the details in the “Gift Card Details” data store and the status is updated to indicate that the card is ready to be activated by the recipient.

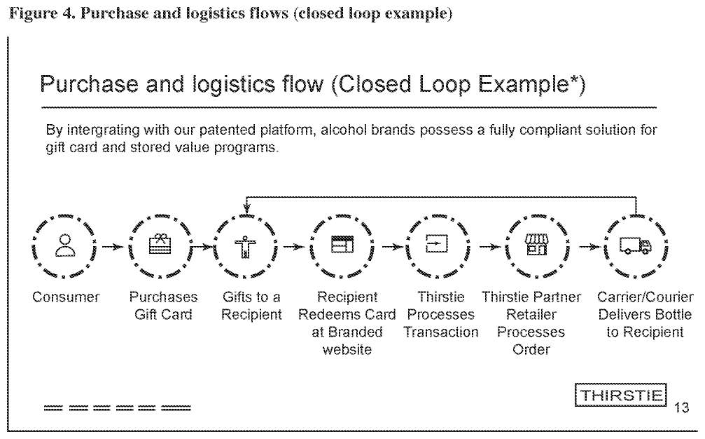

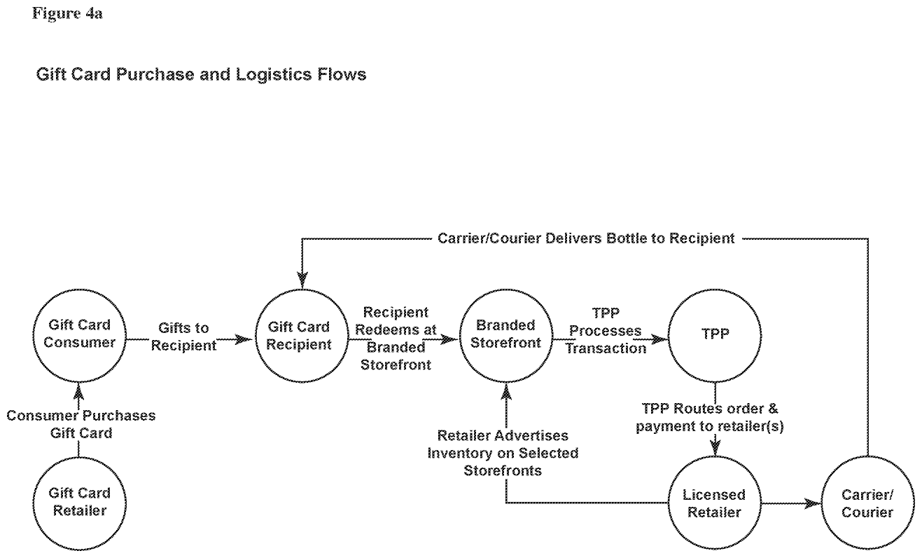

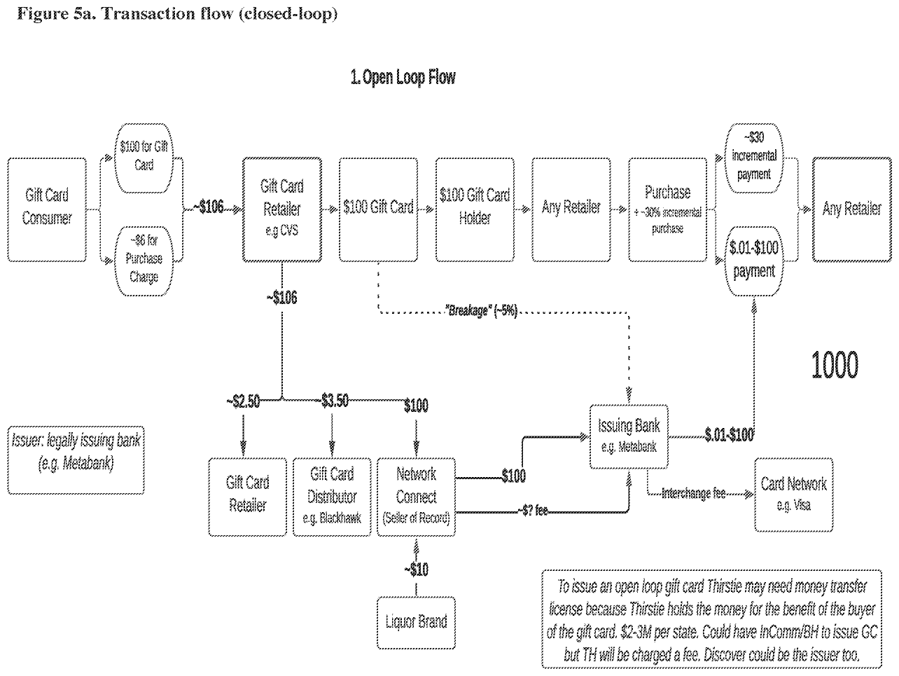

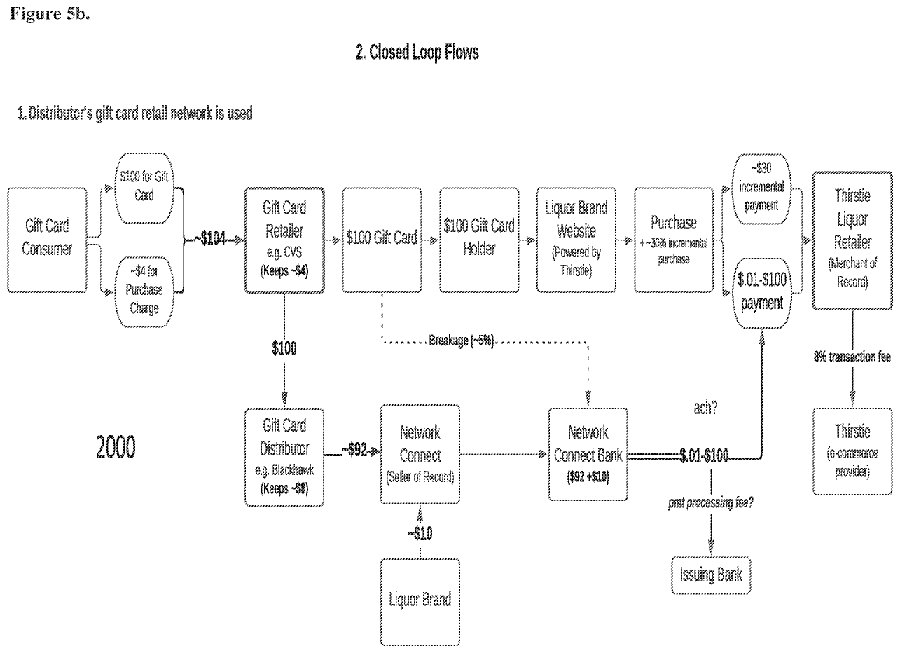

The second process is “2) Activation.” The recipient provides their age and desired delivery location via a form on the branded store front (see FIG. 4). The Activation process uses the object representation of the Gift Card as depicted in FIG. 8 to create two additional objects: 1) the Gift Card Recipient, which represents the recipient agent and 2) Gift Card Locale Status, which represents the result of a validation of if the Gift Card Recipient can redeem the gift card with a delivery to the desired location. The Gift Card Recipient record is linked to the Gift Card Details record. Variants including activation on gift card sale (physical cards), self-activation (“at-home” activation) and e-gift cards (activated on receipt) Achieving compliant implementation of each variant requires a different technological solution in order to achieve compliance with the three-tier system, as well a conventional e-commerce software and entities.

With reference to FIG. 8, the Gift Card Recipient and Gift Card Locale Status objects also create records in the associated data stores. This allows the system to report in fine grained detail on gifting and redemption activity.

For the third process of FIG. 7, “3) Gift Card Product Eligibility by Location,” the Gift Card Locale Status object in FIG. 8 also has the responsibility to determine which products are available for redemption, and if the card can be redeemed for the location. This requires the Product Locale Set, which lists the product, the retailer responsible for each product, and “Locale” in which the product is available. In this context a “Locale” is a geographically defined region, which may be a defined political subdivision or other region, such as a state or postal code. It may also be a set of geolocation coordinates bounding a region. Variants including other redemption eligibility criteria—such as age, or customer actions such as signing up for a newsletter, adding information to the customer's account, etc.

The “getGiftCardLocaleStatus” and “getLocaleProducts” executable code each require transforming an address into geographic coordinates to determine that the address falls into a specified locale.

The FIGS. 7 and 9 depict the Product Locale Set as a data store, but other variants could rely on a dynamically generated list of product, retailer, locale combinations without impacting the overall process.

The final process of FIG. 7, namely “4) Order and Redemption” validates that the gift card has not already been redeemed, that it contains eligible products (which uses the same object and methods in process 3), and then coordinates with the external payment system to route payment from the gift card to the retailer. FIG. 8 shows the Logistic Order object which uses the “validateGiftCardPayment” operation to create a Gift Card Redemption object. The Gift Card Redemption object utilizes the Gift Card Locale Status object to validate that the products contained in the order are in the Product Locale Set.

The Gift Card Redemption object records the results of the redemption via the “createRedemption”, with the status of “Success” or “Failure” in the Gift Card Redemption data store, with the details given in FIG. 9.

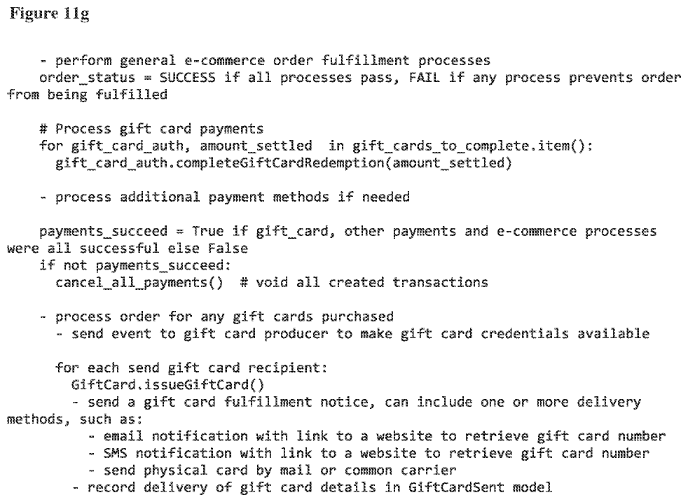

FIG. 11, and FIGS. 11a-g, provide pseudocode for the objects, definitions, executables, and data stores disclosed herein.

What is claimed is:

1. A software class object structure for enabling the issuance and redemption of a third-party gift card for the gifting of beverage alcohol, which includes brand marketing information, and which is configured to provide data for transactions in a manner that such data integrates into a conventional third-party e-commerce platform, the software class object structure comprising:
a gift card object comprising:
a gift card code field;
a gift card value field;
a gift card format definition;
a product set comprising a pointer to a set of authorized products;
a storefront set comprising a pointer to a set of authorized storefronts;
a first gift card object executable code for creating a gift card, comprising code to execute the steps of:
issuing of a unique gift card code and populating the unique gift card code in the gift card code field;
issuing a security code to be used to securely activate the gift card; and
creating either a data set to separately manufacture a physical gift card, or creating a virtual representation of the gift card to allow the recipient of the gift card to access the unique gift code;
a second gift card object executable code for getting gift card details including:
a list of storefronts, retailers, and products eligible for gift card redemption;
a list of any geographic restrictions on gift card redemption;
a current balance of the gift card; and
a status of the gift card;
a third gift card object executable code to authorize an activation code for the gift card; and
a fourth gift card object executable code to activate the gift card using a user detail data and a location data;
wherein the gift card object instantiates a gift card recipient object;
wherein the gift card recipient object comprises:
a first recipient id field;
a first gift card id field;
a first user id field;
a first gift card recipient object executable code to check the status of the recipient; and
a second gift card recipient object executable code to set a location id field;
wherein the gift card recipient object instantiates a gift card locale status object;
wherein the gift card locale status object comprises:
a second recipient id field, which is populated by the data from the first recipient id field;
a second gift card id field, which is populated by the data from the first gift card id field;
a first gift card locale status object executable code to set the gift card locale status;
a second gift card locale status object executable code to get the gift card local status; and
a third gift card locale status object executable code to get a locale products list;
a logistic order object comprising:
a second user id field which is populated by the data from the first user id field;
a second gift card id field which is populated by the data from the first gift card id field;
an other payment details field;
an order details field;
a first logistic order object executable code to validate the gift card payment status; and
a second logistic order object executable code to instantiate a gift card redemption object;
wherein the logistic order object instantiates a gift card redemption object;
wherein the gift card redemption object comprises:
a third recipient id field, which is populated by the data from the second recipient id field;
a third gift card id field, which is populated by the data from the second gift card id field;
a redemption amount field;
a logistic order id field;
a status field;
a timestamp field;
a first gift card redemption object executable code to validate the redemption status;
a second gift card redemption object executable code to complete redemption of the gift card, including the step of effecting the transfer of funds from a gift card account to a retailer account thereby fulfilling redemption; and
wherein the gift card redemption object is configured to call the recipient status executable code and the get local products executable code.

2. The software class object structure of claim 1 wherein the security code is stored separately and functions as a password to access funds associated with the gift card.

3. The software class object structure of claim 1 wherein the representation of the gift card is stored in the gift card recipient object.

4. The software class object structure of claim 1 wherein a list of storefronts, retailers, and products is stored in a retailer storefront mapping object.

5. The software class object structure of claim 1 wherein a list of geographic restrictions are stored in a gift card locale status field in the gift card locale object.

6. The software class object structure of claim 1 wherein a current balance of the gift card is stored in the gift card object.

7. The software class object structure of claim 1 wherein the first gift card recipient object executable code to check the status of the recipient is configured to perform an age verification routine to verify that the individual redeeming the gift card is old enough to purchase beverage alcohol.

8. The software class object structure of claim 1 wherein the logistic order object further comprises:
an first other payments detail executable code, which uses any data present in the other payment details field to determine if an additional payment over and above the current balance on the gift card is required to complete a requested purchase.

9. The software class object structure of claim 1 wherein the second logistic order object executable code includes code to perform preauthorization of an amount needed to be redeemed, thereby placing a hold on funds so as to prevent two simultaneous transactions to redeem the funds twice from the same gift card.

10. The software class object structure of claim 1 further comprising:
a retailer object comprising:
an id field;
a name field;
a details field;
a retailer storefront selection executable code for subscribing to a retailer storefront mapping object; and
a get retailer inventory object for accessing an inventory object;
the inventory object comprising:
a first retailer id field;
a product reference field;
a price field; and
a quantity field;
a retailer storefront mapping object comprising:
a second retailer id field, populated with data from the first retailer id field;
a storefront id field, populated with data from the id field;
an active field, comprising a first Boolean operator to indicate whether the storefront object includes active products for offer;
a giftcard payments field, comprising a second Boolean operator to indicate whether the storefront object is accepting payments by gift card;
a get store fronts for retailer executable code which uses the second retailer id field;
a get retailer inventories for storefront executable code which retrieves a list of products to be advertised via a storefront object;
a storefront object comprising:
a second id field populated by the data from the first id field;
a type field identifying the type of ecommerce application in use;
a second name field populated by the data from the first name field;
a brand field;
wherein the retailer object is configured to facilitate online advertising of inventory that is for sale based upon the inventory object data fields;
wherein the retailer object subscribes to the retailer storefront mapping object; and
wherein the retailer storefront mapping object retrieves the list of products to be advertised based upon the storefront object data fields.

11. A method to enable an online customer to purchase a gift card for the purchase of beverage alcohol via a third-party e-commerce platform (TPP), simultaneously with the online purchase of beverage alcohol for the online customer, through a single checkout experience, while maintaining compliance with three-tier regulatory system for beverage alcohol by carrying out the following steps:
(a) accepting customer input through the TPP interface of the geographic location and form of delivery for the gift card or cards to be purchased;
(b) accepting customer input through the TPP interface of the value to be loaded onto the gift card at activation;
(c) recording the purchase of the gift card with the above details in the TPP system;
(d) determining if the customer payment methods can be used to purchase a gift card and performing regulatory checks to verify that the customer is eligible to purchase a gift card to be used in the later purchase of alcohol; and
(e) transferring the funds represented by the gift card to a segregated account and recording the status of the gift card as ready for activation.

12. The method of claim 11 wherein step (a) further comprises accepting customer input to select whether the gift card will be issued in physical or electronic form.

13. The method of claim 11 wherein step (d) comprises performing age verification.

14. A method for a retailer to dynamically update a list of retailers with whom a gift card can be redeemed in payment for the fulfillment of beverage alcohol in compliance with the three-tier system, where the retailer is not the issuer of the gift card, comprising:
(a) enabling the retailer to select branded e-commerce storefronts on which to advertise beverage alcohol products for sale;
(b) collecting payment account information from the retailer; and
(c) collecting the retailer's opt-in confirmation to receive payments via gift card redemption.

15. A method to enable a customer to redeem a gift card to purchase beverage alcohol and other non-alcohol products through an e-commerce storefront supported by a third-party platform (TPP) by processing payments directly to an online retailer from the gift card in compliance with the three tier system, comprising:
a. checking a list of products and retailers eligible for gift card redemption to identify which products chosen for purchase by the customer can be purchased using gift card funds;
b. preauthorizing gift card redemption when the customer initiates checkout during their e-commerce shopping session;
c. creating a transaction for the amount of the purchased goods from the gift card account to the retailer;
d. collecting any other payments from the customer if there are amounts due to the retailers that cannot be paid from the gift card;
e. voiding the customer order in full if the gift card and other payment transaction is not able to be processed; and
f. completing all payment transactions by effecting the movement of funds only if steps a-d are successfully completed.
